(19) United States
(12) Patent Application Publication
(10) Pub. No.: US 2021/0189867 A1
(43) Pub. Date: Jun. 24, 2021

(54) ADVANCED HYDROCARBON EXTRACTION

(71) Applicant: Halliburton Energy Services, INC., Houston, TX (US)

(72) Inventors: Alan Coats, The Woodlands, TX (US); Robert Hull, Houston, TX (US)

(21) Appl. No.: 16/719,350

(22) Filed: Dec. 18, 2019

(51) Int. Cl. E21B 47/12; E21B 43/16; E21B 43/30

(52) U.S. Cl. CPC E21B 47/12; G06Q 50/04; E21B 43/30; E21B 43/16

(57) ABSTRACT

Hydrocarbon extraction can be expedited and improved. As one example, a system can receive input data describing a technical process for adjusting hydrocarbon production from a well site. The system can then detect a change in hydrocarbon production from the well site resulting from applying the technical process to the well site. The system can associate the change in hydrocarbon production with a number of barrels of hydrocarbons. The system can then determine values for at least two site metrics based on the number of barrels of hydrocarbons, the values indicating an efficacy of the technical process. The system can transmit an output signal comprising the values indicating the efficacy of the technical process. The technical process may then be adjusted based on the content of the output signal, so as to provide a feedback loop that facilitates hydrocarbon extraction from the well site.

### TECHNICAL FIELD

The present disclosure relates generally to hydrocarbon extraction from a subterranean formation using a wellbore. More specifically, but not by way of limitation, this disclosure relates to improving the speed and efficiency with which hydrocarbons are extracted from a wellbore.

### BACKGROUND

Well sites can include one or more wellbores drilled through a subterranean formation for extracting hydrocarbons (e.g., oil or gas) from the subterranean formation. Well sites are generally owned or leased by site operators. Site operators often purchase or rent various technologies (e.g., equipment or software) from service providers to facilitate hydrocarbon production from the well site.

### BRIEF DESCRIPTION OF THE DRAWINGS

FIG. 1 is a cross-sectional side view of an example of a well site according to some aspects.

FIG. 2 is a block diagram of an example of computing device according to some aspects.

FIG. 3 is a flow chart of an example of a process for improving hydrocarbon extraction according to some aspects.

### DETAILED DESCRIPTION

Certain aspects and features of the present disclosure relate to a computing device that receives input data describing a technical process for adjusting hydrocarbon production from a well site. The computing device can then detect a change in hydrocarbon production from the well site as a result of applying the technical process to the well site, and associate the change in hydrocarbon production with a number of barrels of hydrocarbon fluids. The computing device can further determine values for at least two site metrics based on the number of barrels of hydrocarbons. The computing device can then generate an output that includes the values. The output can be used to adjust the technical process (e.g., by the committee or automatically by the computing device) and the above steps can iterate, so as to create a feedback loop that enables faster and more efficient extraction of hydrocarbons from the well site.

As one specific example, the computing device can receive the data about the technical process as input from a committee overseeing hydrocarbon extraction from the well site. The committee can include members from both (i) a site operator of the well site and (ii) a service provider (SP) that provides a technology for implementing the technical process. Including members from both of these parties can leverage the technical expertise of both parties to more rapidly and efficiently harvest the well site.

The technical process can include one or more physical operations for configuring a well site in a particular manner, e.g., to produce hydrocarbons or to improve production of hydrocarbons. Examples of the physical operations can include drilling, perforation, and cementing. The technical process may be implemented via a well tool, such as a drill string, perforating gun, or fishing tool.

After receiving the data input, the computing device can detect a change in hydrocarbon production from the well site as a result of the technical process. For example, the computing device can detect the change based on additional user input that indicates the current level or rate of hydrocarbon production. In another example, the computing device can detect the current level or rate of hydrocarbon production based on a sensor signal from a sensor positioned at the well site, such as a sensor coupled to a pump or storage tank of the well site. Either way, the computing device can determine the change in hydrocarbon production from the well site, e.g., relative to a prior level or rate of hydrocarbon production before the technical process was implemented.

Next, the computing device can associate the change with a number of barrels of hydrocarbons. For example, if the well site is producing 210 more gallons of hydrocarbons per day than it was producing before the technical process was implemented, the computing device can transform this difference into a specific number of barrels of hydrocarbons—e.g., 5 barrels—representing that difference.

The computing device can then determine values for at least two site metrics based on the number of barrels of hydrocarbons. A site metric is a performance property of a well site that indicates how well the well site is producing hydrocarbons. Examples of the site metrics can include a lease-operating-expense metric (LEO) metric and a production metric, both of which are described in greater detail below. After determining the values for the at least two site metrics, the computing device can generate and transmit an output signal (e.g., report) indicating the values. This can enable the technical process to be adjusted and optimized for better hydrocarbon extraction.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

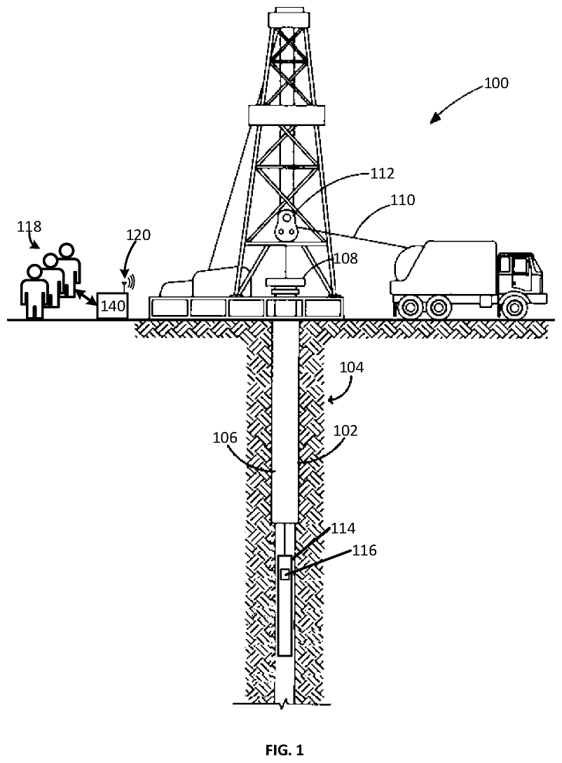

FIG. 1 is a cross-sectional side view of an example of a well site 100 according to some aspects. The well site 100 includes a wellbore 102 extending through various earth strata. The wellbore 102 extends through a hydrocarbon bearing subterranean formation 104. A casing string 106 extends from the well surface 108 to the subterranean formation 104. The casing string 106 can provide a conduit through which formation fluids, such as production fluids produced from the subterranean formation 104, can travel from the wellbore 102 to the well surface 108. The casing string 106 can be coupled to the walls of the wellbore 102 via cement. For example, a cement sheath can be positioned or formed between the casing string 106 and the walls of the wellbore 102 for coupling the casing string 106 to the wellbore 102.

The well site 100 can include one or more well tools, such as well tool 114. A well tool is any physical tool for conducting one or more physical well operations in the wellbore 102 or at the well surface 108. In the example shown in FIG. 1, the well tool 114 is positioned in the wellbore 102 by a guide 110 (e.g., a wireline, slickline, or coiled tube) and winch 112 for performing the well operations downhole. But in other examples, the well tool 114 may be positioned at the well surface 108 for performing the well operations at the surface.

The well tool 114 can include one or more subsystems 116, which in turn may include one or more electronic devices, mechanical devices, or chemical devices, or any combination of these. The subsystems 116 can include sensors (e.g., pressure sensors, temperature sensors, densitometers, acoustic sensors, fiber optic cables, fluid-flow sensors, gamma ray sensors, or any combination of these), motors, pumps, valves, perforating equipment, packers, screens, drilling equipment, or any combination of these. The well tool 114 can be operated to perform one or more technical processes in the wellbore 102, where a technical process can include one or more well operations.

In some examples, the technical processes can be configured to prepare the wellbore 102 for hydrocarbon extraction or to improve hydrocarbon extraction already taking place. Examples of such technical processes can include hydraulic fracturing, sand screening, perforating at select locations, etc. The technical processes can also be configured for additional or alternative applications, such as re-fracturing of a well; maximizing hydrocarbon sales; performing artificial lift, drilling and production chemical applications; modifying surface and sub-surface flow-regimes; artificial intelligence (Al) and machine learning (ML) applications; varying surface and sub-surface safety systems; and optimizing drilling and completion.

The technical processes can be controlled by a committee 118 overseeing operation of the well site 100. The committee 118 can include engineers, field operations specialists, equipment specialists, finance and accounting specialists, and other members from at least two different stakeholders associated with the well site 100. A stakeholder is a distinct entity that has an interest in the success of the well site 100. Examples of the stakeholders can include a site operator that has production rights for the well site, and a service provider that provides a technology (e.g., well tool 114) for implementing the technical processes at the well site 100.

For at least some of the technical processes applied to the wellbore 102, the committee 118 may input data about the technical process to a computing device 140. For example, the committee 118 can provide input data indicating that a particular technical process is being performed or is going to be performed, and may also input one or more characteristics of the particular technical process. The committee 118 can provide the input data to the computing device 140 using an input device, such as a keyboard, mouse, or touchscreen.

After receiving the input data, the computing device 140 may detect a change in hydrocarbon production from the well site 100 (e.g., from the wellbore 102) as a result of applying the technical process to the well site 100. The change can be an increase in hydrocarbon production or a decrease in hydrocarbon production, as compared to the level of hydrocarbon production prior to implementation of the technical process. The computing device 140 may detect the change in any suitable way. For example, the committee 118 may provide additional user input describing the change after a length of time has passed since implementation of the technical process began. Alternatively, the computing device 140 may automatically detect the change based on one or more sensor signals from one or more sensors. For example, the computing device 140 can include a communications interface 120 through which the computing device 140 can engage in wired or wireless communications with the one or more sensors to receive the sensor signals. The one or more sensors may be positioned downhole (e.g., coupled to the well tool 114 or casing string 106), positioned at the well surface 108 (e.g., in a storage tank, on a pump, or on a fluid flow meter), or positioned elsewhere at the well site 100 for detecting the change in hydrocarbon production and indicating the change to the computing device 140.

After detecting the change in hydrocarbon production, the computing device 140 can determine one or more values for one or more site metrics based on the change in hydrocarbon production (as a result of applying the technical process). The site metric values can indicate an efficacy of the technical process. One example of a site metric can be a LEO metric, where LOE is a cost of maintaining and operating property and equipment on a hydrocarbon production lease. The computing device can determine a value for the LOE metric based on a number of barrels of hydrocarbon, a LOE per barrel, a service-provider interest (e.g., an interest attributable to a service provider on the committee 118), or any combination of these. For example, a value for the LOE metric can be determined based on a number of barrels of hydrocarbons sold between two dates, the LOE per barrel, and a service-provider interest (SPI). This can be represented mathematically as: (LOE Per Barrel*SPI)*Barrels Sold. Another example of a site metric can be a production metric. The computing device can determine a value for the production metric based on a number of barrels of hydrocarbon and a barrel attribute, such as a cost per barrel sold. For example, a value for the production metric can be determined based on a number of barrels of hydrocarbons sold between two dates and a fixed cost per barrel sold. This can be represented mathematically as Fixed Cost Per Barrel*Barrels Sold. These site metrics can indicate how well the well site 100 is producing hydrocarbons.

The computing device 140 can then produce an output signal that includes the one or more site metric values, so that the committee 118 can take appropriate action with respect to the technical process. Such actions may include modifying, stopping, or continuing with the technical process, depending on the contents of the output signal.

In one particular example, the committee 118 may decide to adjust the technical process based on the contents of the output signal, in an effort to improve the efficacy of the technical process. The committee 118 may then supply additional user input to the computing device 140 describing or otherwise indicating the adjusted technical process. Alternatively, the computing device 140 can automatically detect an adjustment to the technical process based on one or more sensor signals from one or more sensors via the communications interface 120. For example, the computing device 140 can detect the one or more of following adjustments to the technical process based on one or more sensor signals from the one or more sensors: opening or closing one or more valves, a reversal or change in fluid-flow direction, incorporation or removal of a subsystem 116 of the well tool 114, or any combination of these. The computing device 140 can then determine the adjusted technical process based on the detected adjustments. Either way, the computing device 140 can receive additional data indicating adjusted technical process and then iterate the above operations. For example, the computing device 140 can detect another change in hydrocarbon production from the well site 100 as a result of applying the adjusted technical process. The computing device 140 can determine new values for the site metrics as a result of the adjusted technical process, where the new values indicate an efficacy of the adjusted technical process. The computing device can then transmit another output signal indicating the new values to the committee 118. The signal may enable the committee 118 to determine the efficacy of the adjusted technical process.

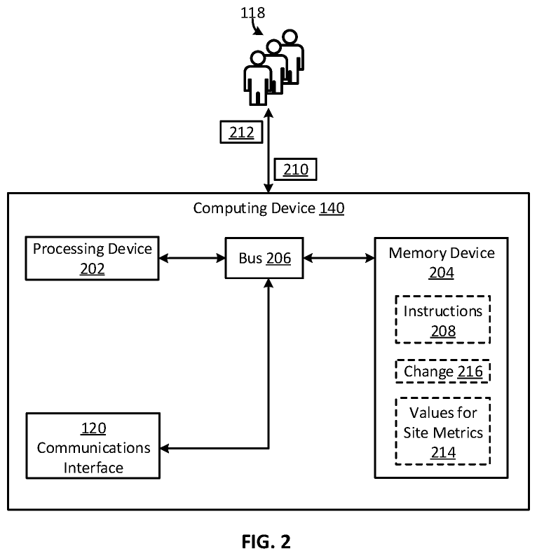

One specific example of the computing device 140 is described in greater detail below with respect to FIG. 2. As shown in FIG. 2, the computing device 140 includes a processor 202 communicatively coupled to a memory device 204 by a bus 206. The processor 202 can include one processor or multiple processors. Non-limiting examples of the processor 202 include a Field-Programmable Gate Array (FPGA), an application-specific integrated circuit (ASIC), a microprocessor, etc. The processor 202 can execute instructions 208 stored in the memory device 204 to perform operations. In some examples, the instructions 208 can include processor-specific instructions generated by a compiler or an interpreter from code written in any suitable computer-programming language, such as C, C++, C#, etc.

The memory device 204 can include one memory device or multiple memory devices. The memory device 204 can be non-volatile and may include any type of memory device that retains stored information when powered off. Non-limiting examples of the memory device 204 include electrically erasable and programmable read-only memory (EEPROM), flash memory, or any other type of non-volatile memory. At least some of the memory device includes a non-transitory computer-readable medium from which the processor 202 can read instructions 208. A non-transitory computer-readable medium can include electronic, optical, magnetic, or other storage devices capable of providing the processor 202 with the instructions 208 or other program code. Non-limiting examples of a non-transitory computer-readable medium include magnetic disk(s), memory chip(s), ROM, random-access memory (RAM), an ASIC, a configured processor, optical storage, or any other medium from which a computer processor can read the instructions 208.

The computing device 140 can also include a communication interface 142. The communication interface 142 can represent one or more components that facilitate a network connection, such as a connection to a local area network (LAN) or a wide area network (WAN). In some examples, the communication interface 142 includes wireless interfaces such as IEEE 802.11, Bluetooth, or radio interfaces for accessing cellular telephone networks (e.g., transceiver/antenna for accessing a CDMA, GSM, UMTS, or other mobile communications network). The communication interface 142 may alternatively use acoustic waves, mud pulses, surface waves, vibrations, optical waves, or induction (e.g., magnetic induction) for engaging in wireless communications. In other examples, the communication interface 142 includes wired interfaces such as Ethernet, USB, IEEE 1394, or a fiber optic interface.

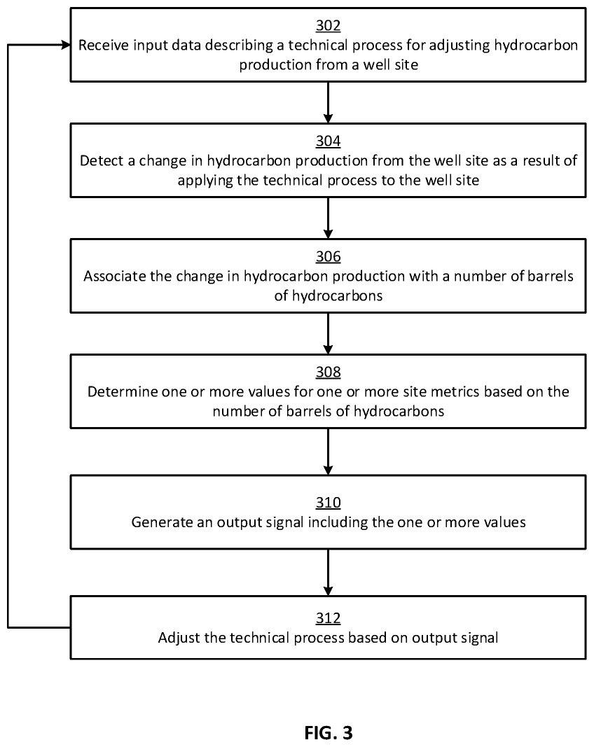

In some examples, the computing device 140 can receive input data 210 describing a technical process for adjusting hydrocarbon production from a well site. The input data 210 can be received from a committee 218 overseeing the well site. The computing device 140 can then detect a change 216 in hydrocarbon production from the well site as a result of applying the technical process to the well site. The computing device 140 may detect the change 216 based on additional user input from the committee or based on sensor signals from one or more sensors positioned at the wellsite or elsewhere (e.g., at a facility offsite at which hydrocarbons are stored). The computing device 140 may then associate the change 216 in hydrocarbon production with a number of barrels of hydrocarbons, and determine values 214 for at least two site metrics based on the number of barrels of hydrocarbons. The values 214 can indicate an efficacy of the technical process. Finally, the computing device 140 can transmit an output signal 210 that includes the values 214, thereby indicating the efficacy of the technical process. In some examples, the computing device 140 can transmit the output signal 210 to a display device (e.g., an LCD display) or a remote computing device, e.g., via the Internet. Some of the above operations are described in further detail below with regard to FIG. 3.

FIG. 3 is a flow chart of an example of a process for improving hydrocarbon extraction according to some aspects. While FIG. 3 depicts a certain sequence of steps for illustrative purposes, other examples can involve more steps, fewer steps, different steps, or a different order of the steps depicted in FIG. 3. The steps of FIG. 3 are described below with reference to components of FIG. 2 above.

In block 302, the computing device 140 receives input data describing a technical process for adjusting hydrocarbon production from a well site. The input data can be received from a committee overseeing the wellsite. In some examples, the input data can be received directly from the committee via an input device, such as a keyboard. In other examples, the input data can be received as an electronic communication over a network (e.g., the Internet) from a remote computing device controlled by the committee.

The input data can include one or more descriptive characteristics of the technical process. Examples of the descriptive characteristics can include a name, duration, type, and cost of the technical process. The input data can also include one or more operational settings of a well tool associated with the technical process. The input data can further include one or more physical characteristics of a wellbore associated with the technical process, such as a shape, depth, dimension (e.g., length, width, circumference, or diameter), or orientation of the wellbore. Additionally, the input data can include one or more material characteristics (e.g., density, porosity, material type, etc.) of a subterranean formation associated with the technical process. The input data can include any amount and combination of the above information, as well as other information.

In block 304, the computing device 140 detects a change 216 in hydrocarbon production from the well site as a result of applying the technical process to the well site. For example, the computing device 140 can receive additional user input indicating a current level or rate of hydrocarbon production as a result of applying the technical process to the well site. Alternatively, the computing device can receive a sensor signal indicating the current level or rate of hydrocarbon production from a sensor positioned at the well site, such as a sensor coupled to a pump or storage tank of the well site. Either way, the computing device 140 may then compare the current level or rate of hydrocarbon production to a baseline level or rate, respectively, obtained prior to implementation of the technical process. The difference there-between can represent the change 216 in hydrocarbon production.

In block 306, the computing device 140 associates the change 216 in hydrocarbon production with a number of barrels of hydrocarbons. For example, the computing device 140 can translate (e.g., convert) the change 216 determined in step 304 into a number of hydrocarbon barrels. The computing device 140 can perform the translation using a predefined conversion ratio, for example, 42 gallons of oil is equal to one barrel (i.e., a ratio of 42:1). The conversion ratio may depend on the type of hydrocarbon being produced (e.g., gas vs. oil) and economic factors.

In block 308, the computing device 140 determines one or more values 214 for one or more site metrics based on the number of barrels of hydrocarbons. For example, the computing device 140 can determine a first value for a first site metric (e.g., the LOE metric) based on the number of barrels of hydrocarbons, a second value for a second site metric (e.g., a production metric) based on the number of barrels of hydrocarbons, or both of these site metrics. Other examples can involve three or more site metrics.

In block 310, the computing device 140 generates an output signal 210 indicating the one or more values 214. For example, the computing device 140 can generate an output signal 210 that includes the one or more values 214. The output signal 210 can be in any suitable format, and include graphs, tables, charts, or other visual elements. The computing device 140 can then transmit the output signal 210 (e.g., to a display device or a remote computing device). The committee 118 can receive the output signal 210 and take appropriate action thereon. Such actions may include modifying, stopping, or continuing with the technical process.

In block 312, the computing device 140 or the committee 118 can adjust the technical process based on the output signal 210, e.g., to improve hydrocarbon production. For example, the computing device 140 can automatically adjust the technical process based on the output signal 210 by transmitting one or more control signals to the one or more well tools (e.g., well tool 114 of FIG. 1) implementing the technical process. The one or more control signals can cause the well tool to adjust an operational setting, so as to adjust at least one aspect of the technical process. As another example, the committee 118 can adjust the technical process based on the output signal 210 by manually modifying an operational setting of the one or more well tools implementing the technical process, so as to adjust at least one aspect of the technical process. Yet another example can involve a combination of the above, whereby the computing device 140 and the committee 118 work together to adjust at least one aspect of the technical process. The adjusted version of the technical process is referred to herein as an adjusted technical process, where the adjusted technical process may be configured to improve the efficacy of the (unadjusted) technical process.

The process may then iterate. For example, the computing device 140 can receive additional data describing or otherwise indicating the adjusted technical process, which the computing device 140 can use as the input data for step 302. The computing device 140 can then detect another change in hydrocarbon production from the well site as a result of applying the adjusted technical process (step 304); associate the other change in hydrocarbon production with a new number of barrels of hydrocarbons (step 306); determine new values for the one or more site metrics based on the new number of barrels of hydrocarbons (step 308); and/or transmit another output signal including the new values (step 310). The computing device 140 or the committee 118 may then further adjust the technical process based on the other output signal (step 312). The process can then iterate again, and so on.

In some aspects, hydrocarbons can be extracted according to one or more of the following examples.

Example #1: A system can include a processing device and a memory device comprising program code that is executable by the processing device for causing the processing device to perform operations. The operations can include receiving input data describing a technical process for adjusting hydrocarbon production from a well site, the input data being received from a committee overseeing the well site. The operations can include detecting a change in hydrocarbon production from the well site as a result of applying the technical process to the well site. The operations can include associating the change in hydrocarbon production with a number of barrels of hydrocarbons. The operations can include determining values for at least two site metrics based on the number of barrels of hydrocarbons, the values indicating an efficacy of the technical process. The operations can include transmiting an output signal comprising the values and thereby indicating the efficacy of the technical process.

Example #2: The system of Example #1 may feature the values including a first value for a first site metric, wherein the first value is determined based on the number of barrels of hydrocarbons and a barrel attribute.

Example #3: The system of any of Examples #1-2 may feature the values including a second value for a second site metric, wherein the second value is determined based on the number of barrels of hydrocarbons, a service-provider interest, and an site-operator overhead.

Example #4: The system of any of Examples #1-3 may feature the memory device further comprising program code that is executable by the processing device for causing the processing device to, subsequent to transmitting the output signal: receive additional data indicating an adjusted technical process, the adjusted technical process being an adjusted version of the technical process configured to improve the efficacy of the technical process; detect another change in hydrocarbon production from the well site as a result of applying the adjusted technical process; associate the other change in hydrocarbon production with a new number of barrels of hydrocarbons; determine new values for the at least two site metrics based on the new number of barrels of hydrocarbons, the new values indicating an efficacy of the adjusted technical process; and/or transmit another output signal comprising the new values and thereby indicating the efficacy of the adjusted technical process.

Example #5: The system of any of Examples #1-4 may feature the memory device further comprising program code that is executable by the processing device for causing the processing device to detect the change in hydrocarbon production from the well site by receiving one or more sensor signals from one or more sensors positioned at the well site, the one or more sensor signals indicating the change in hydrocarbon production.

Example #6: The system of any of Examples #1-5 may feature the change in production being an increase in hydrocarbon production from the well site, and the number of barrels of hydrocarbons being greater than a previous number of barrels of hydrocarbons produced from the well site prior to the change.

Example #7: The system of any of Examples #1-6 may feature the committee comprising members from (i) a first stakeholder that has production rights for the well site and (ii) a second stakeholder that provides a technology for implementing the technical process on the well site, the first stakeholder being different from the second stakeholder.

Example #8: A method can include receiving input data describing a technical process for adjusting hydrocarbon production from a well site, the input data being received from a committee overseeing the well site. The method can include detecting a change in hydrocarbon production from the well site as a result of applying the technical process to the well site. The method can include associating the change in hydrocarbon production with a number of barrels of hydrocarbons. The method can include determining values for at least two site metrics based on the number of barrels of hydrocarbons, the values indicating an efficacy of the technical process. The method can include transmitting an output signal comprising the values and thereby indicating the efficacy of the technical process. Some or all of the above steps can be implemented by a processing device.

Example #9: The method of Example #8 may involve the values including a first value for a first site metric, wherein the first value is determined based on the number of barrels of hydrocarbons and a barrel attribute.

Example #10: The method of any of Examples #8-9 may involve the values including a second value for a second site metric, where the second value is determined based on the number of barrels of hydrocarbons, a service-provider interest, and an site-operator overhead.

Example #11: The method of any of Examples #8-10 may involve, subsequent to transmitting the output signal: receiving additional data indicating an adjusted technical process, the adjusted technical process being an adjusted version of the technical process configured to improve the efficacy of the technical process; detecting another change in hydrocarbon production from the well site as a result of applying the adjusted technical process; associating the other change in hydrocarbon production with a new number of barrels of hydrocarbons; determining new values for the at least two site metrics based on the new number of barrels of hydrocarbons, the new values indicating an efficacy of the adjusted technical process; and/or transmitting another output signal comprising the new values and thereby indicating the efficacy of the adjusted technical process.

Example #12: The method of any of Examples #8-11 may involve detecting the change in hydrocarbon production from the well site by receiving one or more sensor signals from one or more sensors positioned at the well site, the one or more sensor signals indicating the change in hydrocarbon production.

Example #13: The method of any of Examples #8-12 may involve the change in production being an increase in hydrocarbon production from the well site, wherein the number of barrels of hydrocarbons is greater than a previous number of barrels of hydrocarbons produced from the well site prior to the change.

Example #14: The method of any of Examples #8-13 may involve the change in production being a decrease in hydrocarbon production from the well site, wherein the number of barrels of hydrocarbons is less than a previous number of barrels of hydrocarbons produced from the well site prior to the change.

Example #15: A non-transitory computer-readable medium comprising program code that is executable by a processing device for causing the processing device to perform operations. The operations can include receiving input data describing a technical process for adjusting hydrocarbon production from a well site, the input data being received from a committee overseeing the well site. The operations can include detecting a change in hydrocarbon production from the well site as a result of applying the technical process to the well site. The operations can include associating the change in hydrocarbon production with a number of barrels of hydrocarbons. The operations can include determining values for at least two site metrics based on the number of barrels of hydrocarbons, the values indicating an efficacy of the technical process. The operations can include transmiting an output signal comprising the values and thereby indicating the efficacy of the technical process.

Example #16: The non-transitory computer-readable medium of Example #15 may feature at least one of the values being determined based on the number of barrels of hydrocarbons and a barrel attribute.

Example #17: The non-transitory computer-readable medium of any of Examples #15-16 may feature at least one of the values being determined based on the number of barrels of hydrocarbons, a service-provider interest, and an site-operator overhead.

Example #18: The non-transitory computer-readable medium of any of Examples #15-17 may feature program code that is executable by the processing device for causing the processing device to, subsequent to transmitting the output signal: receive additional data indicating an adjusted technical process, the adjusted technical process being an adjusted version of the technical process configured to improve the efficacy of the technical process; detect another change in hydrocarbon production from the well site as a result of applying the adjusted technical process; associate the other change in hydrocarbon production with a new number of barrels of hydrocarbons; determine new values for the at least two site metrics based on the new number of barrels of hydrocarbons, the new values indicating an efficacy of the adjusted technical process; and/or transmit another output signal comprising the new values and thereby indicating the efficacy of the adjusted technical process.

Example #19: The non-transitory computer-readable medium of any of Examples #15-18 may feature program code that is executable by the processing device for causing the processing device to detect the change in hydrocarbon production from the well site by receiving one or more sensor signals from one or more sensors positioned at the well site, the one or more sensor signals indicating the change in hydrocarbon production.

Example #20: The non-transitory computer-readable medium of any of Examples #15-18 may feature the change in production being a decrease in hydrocarbon production from the well site, and wherein the number of barrels of hydrocarbons is less than a previous number of barrels of hydrocarbons produced from the well site prior to the change.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, examples described herein can be combined together to yield still further examples.

1. A system comprising:
a processing device; and
a memory device comprising program code that is executable by the processing device for causing the processing device to:
receive input data describing a technical process for adjusting hydrocarbon production from a well site, the input data being received from a committee overseeing the well site;
detect a change in hydrocarbon production from the well site as a result of applying the technical process to the well site;
associate the change in hydrocarbon production with a number of barrels of hydrocarbons;
determine values for at least two site metrics based on the number of barrels of hydrocarbons, the values indicating an efficacy of the technical process; and
transmit an output signal comprising the values and thereby indicating the efficacy of the technical process.

2. The system of claim 1, wherein the values includes a first value for a first site metric, wherein the first value is determined based on the number of barrels of hydrocarbons and a barrel attribute.

3. The system of claim 2, wherein the values includes a second value for a second site metric, wherein the second value is determined based on the number of barrels of hydrocarbons, a service-provider interest, and an site-operator overhead.

4. The system of claim 1, wherein the memory device further comprises program code that is executable by the processing device for causing the processing device to, subsequent to transmitting the output signal:
receive additional data indicating an adjusted technical process, the adjusted technical process being an adjusted version of the technical process configured to improve the efficacy of the technical process;
detect another change in hydrocarbon production from the well site as a result of applying the adjusted technical process;
associate the other change in hydrocarbon production with a new number of barrels of hydrocarbons;
determine new values for the at least two site metrics based on the new number of barrels of hydrocarbons, the new values indicating an efficacy of the adjusted technical process; and
transmit another output signal comprising the new values and thereby indicating the efficacy of the adjusted technical process.

5. The system of claim 1, wherein the memory device further comprises program code that is executable by the processing device for causing the processing device to detect the change in hydrocarbon production from the well site by receiving one or more sensor signals from one or more sensors positioned at the well site, the one or more sensor signals indicating the change in hydrocarbon production.

6. The system of claim 1, wherein the change in production is an increase in hydrocarbon production from the well site, and wherein the number of barrels of hydrocarbons is greater than a previous number of barrels of hydrocarbons produced from the well site prior to the change.

7. The system of claim 1, wherein the committee comprises members from (i) a first stakeholder that has production rights for the well site and (ii) a second stakeholder that provides a technology for implementing the technical process on the well site, the first stakeholder being different from the second stakeholder.

8. A method comprising:
receiving, by a processing device, input data describing a technical process for adjusting hydrocarbon production from a well site, the input data being received from a committee overseeing the well site;
detecting, by the processing device, a change in hydrocarbon production from the well site as a result of applying the technical process to the well site;
associating, by the processing device, the change in hydrocarbon production with a number of barrels of hydrocarbons;
determining, by the processing device, values for at least two site metrics based on the number of barrels of hydrocarbons, the values indicating an efficacy of the technical process; and
transmitting, by the processing device, an output signal comprising the values and thereby indicating the efficacy of the technical process.

9. The method of claim 8, wherein the values includes a first value for a first site metric, wherein the first value is determined based on the number of barrels of hydrocarbons and a barrel attribute.

10. The method of claim 9, wherein the values includes a second value for a second site metric, wherein the second value is determined based on the number of barrels of hydrocarbons, a service-provider interest, and an site-operator overhead.

11. The method of claim 8, further comprising, subsequent to transmitting the output signal:
receiving additional data indicating an adjusted technical process, the adjusted technical process being an adjusted version of the technical process configured to improve the efficacy of the technical process;
detecting another change in hydrocarbon production from the well site as a result of applying the adjusted technical process;
associating the other change in hydrocarbon production with a new number of barrels of hydrocarbons;
determining new values for the at least two site metrics based on the new number of barrels of hydrocarbons, the new values indicating an efficacy of the adjusted technical process; and
transmitting another output signal comprising the new values and thereby indicating the efficacy of the adjusted technical process.

12. The method of claim 8, wherein detecting the change in hydrocarbon production from the well site comprises receiving one or more sensor signals from one or more sensors positioned at the well site, the one or more sensor signals indicating the change in hydrocarbon production.

13. The method of claim 8, wherein the change in production is an increase in hydrocarbon production from the well site, and wherein the number of barrels of hydrocarbons is greater than a previous number of barrels of hydrocarbons produced from the well site prior to the change.

14. The method of claim 8, wherein the change in production is a decrease in hydrocarbon production from the well site, and wherein the number of barrels of hydrocarbons is less than a previous number of barrels of hydrocarbons produced from the well site prior to the change.

15. A non-transitory computer-readable medium comprising program code that is executable by a processing device for causing the processing device to:
receive input data describing a technical process for adjusting hydrocarbon production from a well site, the input data being received from a committee overseeing the well site;
detect a change in hydrocarbon production from the well site as a result of applying the technical process to the well site;
associate the change in hydrocarbon production with a number of barrels of hydrocarbons;
determine values for at least two site metrics based on the number of barrels of hydrocarbons, the values indicating an efficacy of the technical process; and
transmit an output signal comprising the values and thereby indicating the efficacy of the technical process.

16. The non-transitory computer-readable medium of claim 15, wherein at least one of the values is determined based on the number of barrels of hydrocarbons and a barrel attribute.

17. The non-transitory computer-readable medium of claim 15, wherein at least one of the values is determined based on the number of barrels of hydrocarbons, a service-provider interest, and an site-operator overhead.

18. The non-transitory computer-readable medium of claim 15, further comprising program code that is executable by the processing device for causing the processing device to, subsequent to transmitting the output signal:
receive additional data indicating an adjusted technical process, the adjusted technical process being an adjusted version of the technical process configured to improve the efficacy of the technical process;
detect another change in hydrocarbon production from the well site as a result of applying the adjusted technical process;
associate the other change in hydrocarbon production with a new number of barrels of hydrocarbons;
determine new values for the at least two site metrics based on the new number of barrels of hydrocarbons, the new values indicating an efficacy of the adjusted technical process; and
transmit another output signal comprising the new values and thereby indicating the efficacy of the adjusted technical process.

19. The non-transitory computer-readable medium of claim 15, further comprising program code that is executable by the processing device for causing the processing device to detect the change in hydrocarbon production from the well site by receiving one or more sensor signals from one or more sensors positioned at the well site, the one or more sensor signals indicating the change in hydrocarbon production.

20. The non-transitory computer-readable medium of claim 15, wherein the change in production is a decrease in hydrocarbon production from the well site, and wherein the number of barrels of hydrocarbons is less than a previous number of barrels of hydrocarbons produced from the well site prior to the change.
